(19) United States
(12) Patent Application Publication
(10) Pub. No.: US 2021/0258923 A1
(43) Pub. Date: Aug. 19, 2021

(54) USER DEVICE

(71) Applicant: NTT DOCOMO, INC., Tokyo (JP)

(72) Inventors: Yuichi Kakishima, Chiyoda-ku, Tokyo (JP); Ryosuke Osawa, Chiyoda-ku, Tokyo (JP)

(73) Assignee: NTT DOCOMO, INC., Tokyo (JP)

(21) Appl. No.: 17/262,039

(22) PCT Filed: Sep. 27, 2018
(86) PCT No.: PCT/JP2018/036123

§ 371 Date: Jan. 21, 2021

(51) Int. Cl. H04W 72/02; H04W 72/04; H04W 4/40; H04W 56/00

(52) U.S. Cl. CPC H04W 72/02; H04W 72/0446; H04W 56/005; H04W 4/40; H04W 72/0453

(57) ABSTRACT

A user device includes a control unit that arranges a reference signal or a gap in a signal of D2D direct communication and a transmitting unit that transmits the signal of the D2D direct communication and information related to the reference signal or the gap to another user device.

### TECHNICAL FIELD

The present invention relates to a user device in a wireless communication system.

### BACKGROUND ART

In Long Term Evolution (LTE), successor systems of LTE (for example, LTE-Advanced (LTE-A), and New Radio (NR) (also called 5G)), device to device (D2D) technology in which user devices perform communication directly with each other without going through a base station device is discussed (for example, Non-Patent Document 1).

In D2D, it is possible to reduce traffic between a user device and a base station device, and communication between user devices can be performed even when a base station device is unable to perform communication in the event of a disaster or the like. In 3rd Generation Partnership Project (3GPP), D2D is called “sidelink,” but D2D which is a more general term is used in this specification. However, in the description of an embodiment to be described later, a sidelink is also used if necessary.

D2D communication is roughly classified into D2D discovery for discovering other devices which are capable of performing communication and D2D communication (also referred to as “D2D direct communication”) in which direct communication between user devices is performed. Hereinafter, when D2D communication, D2D discovery, and the like are not particularly distinguished, they are referred to simply as D2D. A signal transmitted and received by D2D is referred to as a D2D signal. In NR, various use cases of services related to vehicle to everything (V2X) are discussed (for example, Non-Patent Document 2).

### CITATION LIST

### Non-Patent Document

Non-Patent Document 1: 3GPP TS 36.211 V15.2.0 (2018-06)
Non-Patent Document 2: 3GPP TR 22.886 V15.1.0 (2017-03)

### SUMMARY OF THE INVENTION

### Problem to be Solved by the Invention

In D2D direct communication in V2X, because static or semi-static power control is difficult unlike in ordinary downlink or uplink, power control by automatic gain control (AGC) is performed for each received packet. For this reason, an AGC-reference signal (RS) is multiplexed at a first symbol of a packet. Further, a gap for switching between transmission and reception is multiplexed at a last symbol of a packet.

The present invention has been made in view of the foregoing, and it is an object of the present invention to enable a user device to execute communication with high transmission efficiency using a signal format with less restrictions in D2D direct communication.

### Means for Solving Problem

According to the technology of the disclosure, provided is a user device including a control unit that arranges a reference signal or a gap in a signal of D2D direct communication and a transmitting unit that transmits the signal of the D2D direct communication and information related to the reference signal or the gap to another user device.

### Effect of the Invention

According to the technology of the disclosure, a user device can execute communication with high transmission efficiency using a signal format with less restrictions in D2D direct communication.

### BRIEF DESCRIPTION OF DRAWINGS

FIG. 1 is a diagram for describing V2X;

FIG. 2 is a diagram for describing direct communication in V2X;

FIG. 3 is a diagram for describing communication going through a base station in V2X;

FIG. 4 is a diagram illustrating an example of a sidelink signal;

FIG. 5 is a diagram for describing an example of communication in an asynchronous state;

FIG. 6 is a diagram for describing an example of communication in a synchronous state;

FIG. 7 is a diagram illustrating an example (1) of a sidelink signal in an embodiment of the present invention;

FIG. 8 is a diagram illustrating an example (2) of a sidelink signal in an embodiment of the present invention;

FIG. 9 is a diagram illustrating an example (3) of a sidelink signal in an embodiment of the present invention;

FIG. 10 is a diagram illustrating an example of scheduling of sidelink in an embodiment of the present invention;

FIG. 11 is a diagram illustrating an example of a gap by TA of sidelink in an embodiment of the present invention;

FIG. 12 is a diagram illustrating an example of a gap configuration of sidelink in an embodiment of the present invention;

FIG. 13 is a diagram illustrating an example of a functional configuration of a base station device 10 in an embodiment of the present invention;

FIG. 14 is a diagram illustrating an example of a functional configuration of a user device 20 in an embodiment of the present invention; and

FIG. 15 is a diagram illustrating an example of a hardware configuration of a base station device 10 or a user device 20 in an embodiment of the present invention.

### MODE(S) FOR CARRYING OUT THE INVENTION

Hereinafter, an embodiment of the present invention will be described with reference to the appended drawings. Note that the following is an example, and an embodiment to which the present invention is applied is not limited to the following embodiment.

In an operation of a wireless communication system of an embodiment of the present invention, existing technology is appropriately used. Here, the existing technology is, for example, existing LTE but not limited to existing LTE. Further, the term “LTE” used in this specification should have a broad meaning including LTE-Advanced and a scheme after LTE-Advanced (for example, NR), or a wireless local area network (LAN) unless otherwise specified herein.

In an embodiment of the present invention, a duplex scheme may be a time division duplex (TDD) scheme, a frequency division duplex (FDD) scheme, or any other scheme (for example, a flexible duplex or the like).

Further, in an embodiment of the present invention, when a wireless parameter or the like is configured, it may mean that a predetermined value is “pre-configured” or it may mean that a wireless parameter indicated by the base station device 10 or the user device 20 is configured.

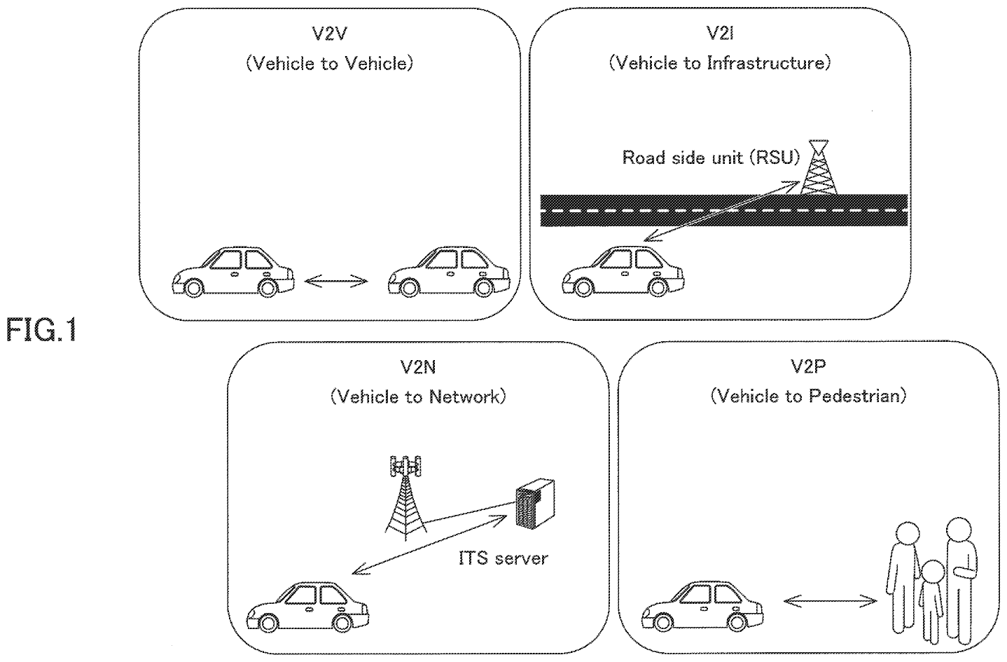

FIG. 1 is a diagram for describing V2X. In 3GPP, implementing vehicle to everything (V2X) or enhanced V2X (eV2X) by extending a D2D function is discussed, and development of technical specifications thereof is in progress. As illustrated in FIG. 1, V2X is a part of intelligent transport systems (ITS) and is a generic term of vehicle to vehicle (V2V) meaning a communication mode performed between vehicles, vehicle to infrastructure (V2I) meaning a communication mode performed between a vehicle and a road-side unit (RSU) installed on a road side, vehicle to network (V2N) meaning a communication mode performed between a vehicle and an IT server, and vehicle to pedestrian (V2P) meaning a communication mode performed between a vehicle and a mobile terminal carried by a pedestrian.

In 3GPP, V2X using cellular communication and inter-terminal communication of LTE or NR is discussed. V2X using cellular communication is also referred to as cellular V2X. In V2X of NR, discussions for realizing large-capacity, low-delay, and high-reliability Quality of Service (QoS) control are conducted.

With respect to V2X of LTE or NR, discussions not limited to 3GPP specifications are expected to be conducted in the future. For example: securing of interoperability; cost reduction by implementation of an upper layer; a method of combining or switching a plurality of radio access technologies (RATs); responding to regulations in each country; and data acquisition, delivery, database management, and use methods of V2X platform of LTE or NR, are expected to be discussed.

In an embodiment of the present invention, a case in which a communication device is installed in a vehicle is mainly assumed, but the embodiment of the present invention is not limited to this embodiment. For example, the communication device may be a terminal carried by a person, the communication device may be a device installed in a drone or an aircraft, and the communication device may be a base station, an RSU, a relay station (relay node), a user device having a scheduling capability, or the like.

Note that sidelink (SL) may be distinguished from uplink (UL) or downlink (DL) on the basis of one of the following 1) to 4) or a combination thereof. Further, SL may have any other name.

1) A resource arrangement in a time domain

2) A resource arrangement in a frequency domain

3) A referenced synchronization signal (including a sidelink synchronization signal (SLSS))

4) A reference signal used for path loss measurement for transmission power control

Further, for orthogonal frequency division multiplexing (OFDM) of SL or UL, any one of cyclic-prefix OFDM (CP-OFDM), discrete Fourier transform-spread-OFDM (DFT-S-OFDM), non-transform pre-coded OFDM, and transform pre-coded OFDM may be applied.

In SL of LTE, Mode 3 and Mode 4 are specified for SL resource allocation to the user device 20. In Mode 3, transmission resources are dynamically allocated in accordance with downlink control information (DCI) transmitted from the base station device 10 to the user device 20. In Mode 3, semi persistent scheduling (SPS) can be performed as well. In Mode 4, the user device 20 autonomously selects transmission resources from a resource pool.

A slot in an embodiment of the present invention may be replaced with a symbol, a mini slot, a sub frame, a radio frame, a transmission time interval (TTI), or the like. Further, a cell in an embodiment of the present invention may be replaced with a cell group, a carrier component, a BWP, a resource pool, a resource, a Radio Access Technology (RAT), or a system (including a wireless LAN).

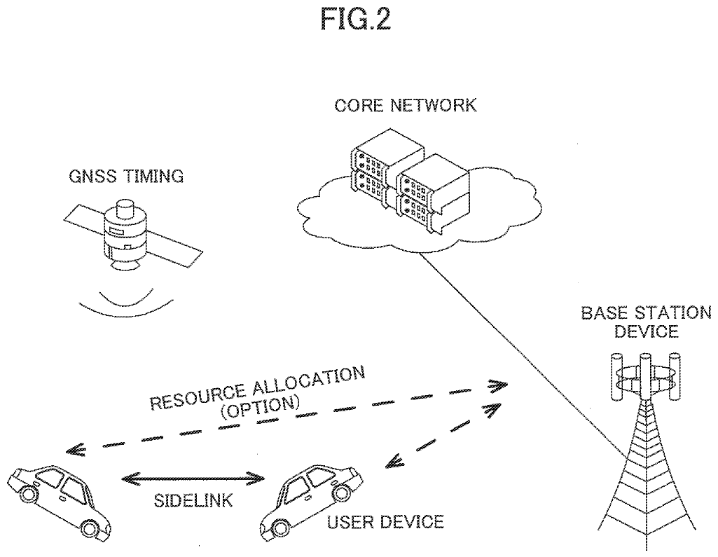

FIG. 2 is a diagram for describing direct communication in V2X. As illustrated in FIG. 2, among communication types in V2X, direct communication (sidelink) is executed from a user device to user device by broadcasting via sidelink. A resource to be used for sidelink may be allocated by a base station device and a core network. As a synchronization timing, a signal from a global navigation satellite system (GNSS) may be referred to. The direct communication is extended from public safety communication to V2X, and is discussed.

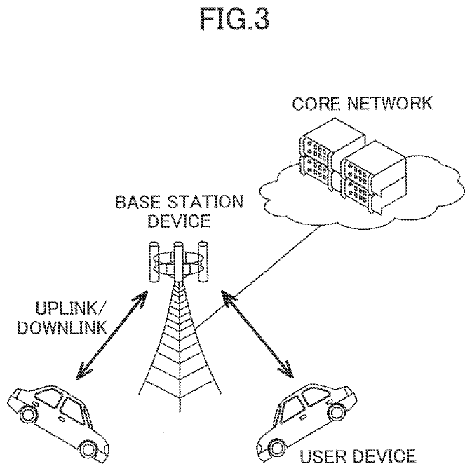

FIG. 3 is a diagram for describing communication going through a base station in V2X. As illustrated in FIG. 3, among communication types in V2X, communication (UL and DL) going through a base station is executed between a user device, and a base station device and a core network, UL is executed in a unicast manner, and DL is executed by unicasting or by broadcasting.

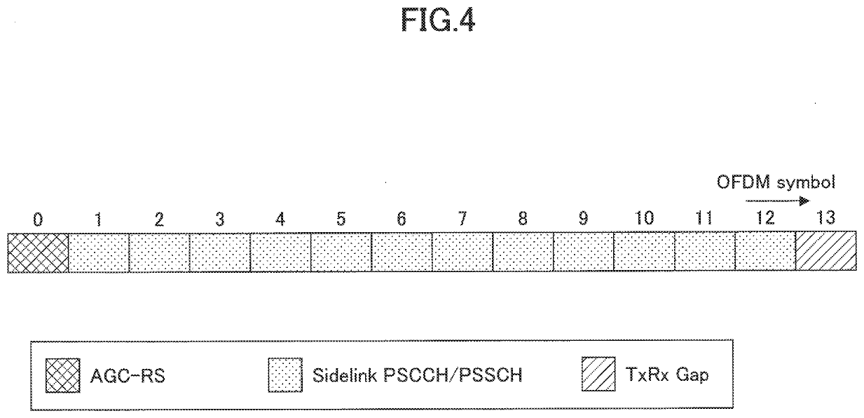

FIG. 4 is a diagram illustrating an example of a sidelink signal. In a packet of sidelink of LTE, as illustrated in FIG. 4, the AGC-RS is multiplexed with a first symbol, and a transmission/reception gap (TxRxGap) is multiplexed with a last symbol. In V2X, because fine power control is difficult as in normal DL or UL, the user device controls the AGC based on the AGC-RS for each received packet. The transmission/reception gap is allocated because a gap is necessary for switching from transmission to reception or switching from reception to transmission. As illustrated in FIG. 4, a Physical Sidelink Control Channel (PSCCH) or a Physical Sidelink Shared Channel (PSSCH) of sidelink may be arranged from a symbol #1 to a symbol #12.

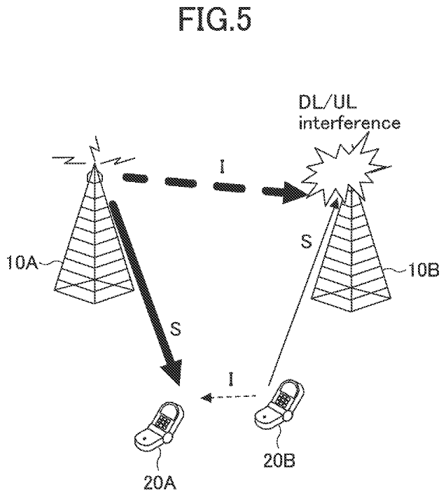

FIG. 5 is a diagram for describing an example of communication in an asynchronous state. In the case of asynchronous communication, DL and UL may occur at the same time. As illustrated in FIG. 5, when DL and UL occur at the same time, a signal S is transmitted from a base station device 10A to a user device 20A, and an interference I occurs at a base station device 10B. The signal S is transmitted from a user device 20B to the base station device 10B, and an interference I occurs at the user device 20A. Here, in the user device 20A, because signal power from the base station device 10A is greater than interference power from the user device 20B, no significant problem occurs in receiving a signal from the base station device 10A. On the other hand, in the base station device 10B, because the interference power from the base station device 10A is greater than the signal power from the user device 20B, a problem occurs in receiving a signal from the user device 20B.

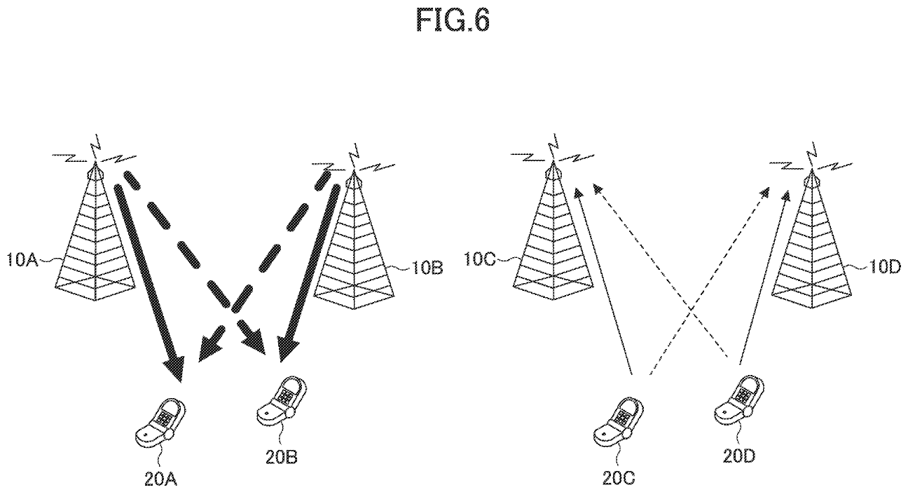

FIG. 6 is a diagram for describing an example of communication in a synchronous state. In the case of synchronous communication, DL and UL each occur in a synchronous manner. As illustrated in FIG. 6, when DL occurs in a synchronous manner, a signal is transmitted from a base station device 10A to a user device 20A, and interference occurs at a user device 20B. A signal is transmitted from a base station device 10B to the user device 20B, and interference occurs at the user device 20A. Here, in the user device 20A, because the signal power from the base station device 10A is greater than the interference power from the base station device 10B, no significant problem occurs in receiving the signal from the base station device 10A. Further, in the user device 20B, since the signal power from the base station device 10B is larger than the interference power from the base station device 10A, no significant problem occurs in receiving the signal from the base station device 10B.

Further, as illustrated in FIG. 6, when UL occurs in a synchronous manner, a signal is transmitted from the user device 20A to the base station device 10A, and interference occurs at the base station device 10B. A signal is transmitted from the user device 20B to the base station device 10B, and interference occurs at the base station device 10A. Here, in the base station device 10A, because the signal power from the user device 20A is greater than the interference power from the user device 20B, no significant problem occurs in receiving a signal from the user device 20A. Further, in the base station device 10B, because the signal power from the user device 20B is greater than the interference power from the user device 20A, no significant problem occurs in receiving a signal from the user device 20B.

As described above, in DL or UL which is not SL, it is necessary to synchronize a timing between cells in order to suppress interference between DL and UL. On the other hand, in SL, generally, a power difference of transmission signals of different links is not as large as that in DL and UL.

Further, in NR, because an OFDM symbol length is inversely proportional to a sub carrier spacing (SCS), the number of symbols necessary for the AGC-RS and the gap is considered not to become 1 as in LTE.

In an embodiment of the present invention, a sidelink technology with high transmission efficiency in which characteristics and restrictions of sidelink are considered is proposed.

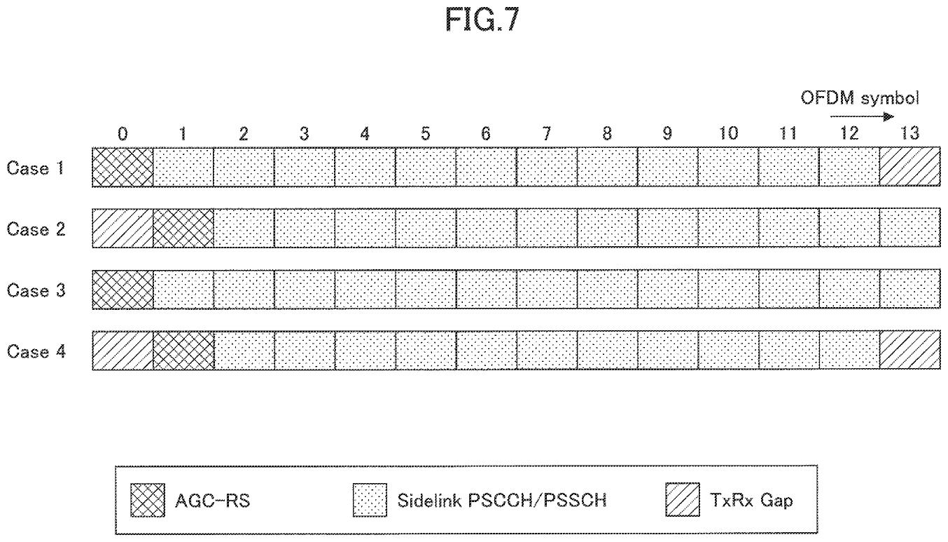

FIG. 7 is a diagram illustrating an example (1) of a sidelink signal in an embodiment of the present invention. In the SL signal, a gap position need not be necessarily multiplexed at a last symbol of a slot and may be multiplexed at a first symbol of a slot. In a case in which the gap position is fixed, restrictions are added with respect to multiplexing with other reference signals. Therefore, the gap position is not fixed. By not fixing the gap position, it is possible to prevent a collision with a signal multiplexed at an end of a slot, such as a sounding reference signal (SRS).

As in Case 1 illustrated in FIG. 7, the AGC-RS may be arranged at the beginning of a slot, and a gap period may be arranged at the end of a slot.

Further, as in Case 2 illustrated in FIG. 7, the gap period and the AGC-RS may be arranged consecutively at the beginning of a slot. Further, for example, each length of the gap period and the AGC-RS may be set freely such that a combined length of the gap period and the AGC-RS is 2 symbols, and for example, the gap period is set to 0.5 symbols, and the AGC-RS is set to 1.5 symbols.

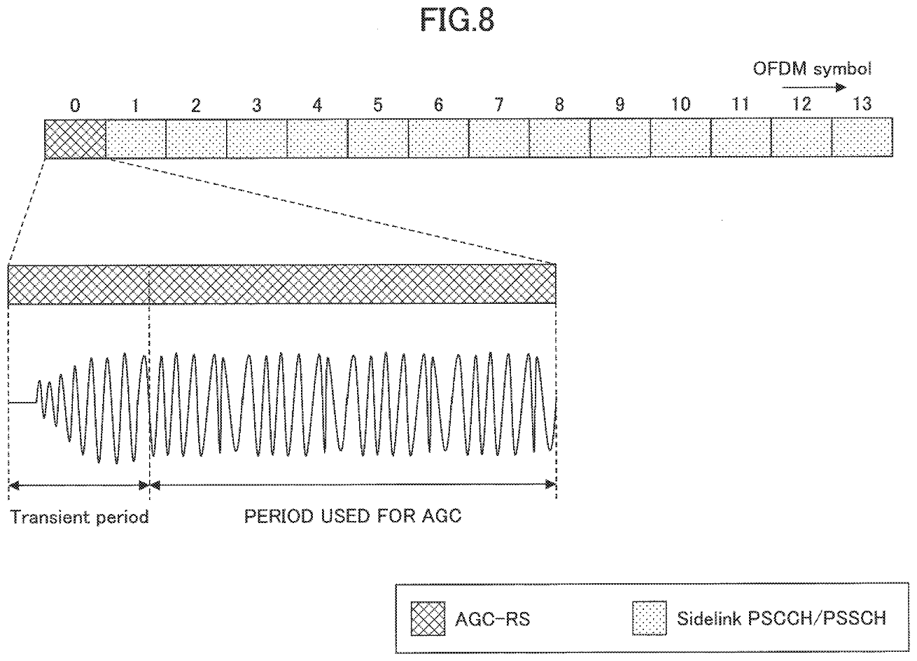

Further, as in Case 3 illustrated in FIG. 7, it is not necessary to explicitly set the gap period. The details will be described with reference to FIG. 8.

Further, as in Case 4 illustrated in FIG. 7, the gap period may be arranged at the beginning and the end of a slot.

The user device 20 or the base station device 10 may switch Cases 1 to 4 of the arrangement of the AGC-RS and the gap period. The user device 20 or the base station device 10 may perform signaling of information indicating the switching of Cases 1 to 4 of the arrangement of the AGC-RS and the gap period.

FIG. 8 illustrates an example (2) of the sidelink signal in an embodiment of the present invention. FIG. 7 is an enlarged diagram of Case 3 in FIG. 7. A first symbol includes a transient period and a period which can be used for AGC. The gap period may be specified as a transient period or a period similar thereto, and the gap period need not be necessarily set explicitly. For example, a transmitter need not guarantee transmission signal performance in the transient period. The transmission signal performance is, for example, modulation performance. For example, a receiver need not guarantee reception performance in the transient period. For example, the receiver may not apply the signal included in the transient period to the AGC.

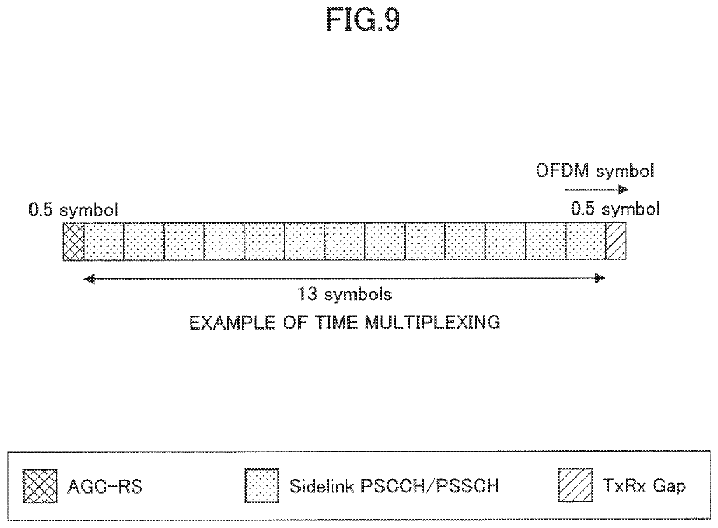

FIG. 9 is a diagram illustrating an example (3) of the sidelink signal in an embodiment of the present invention. The AGC-RS length and the gap length may be variable. For example, the AGC-RS length and the gap length may be determined for each SCS. Table 1 shows a correspondence between the SCS and the OFDM symbol length.

TABLE 1

| | OFDM symbol |
|---|---|
| SCS | duration |
| 15 kHz | 66.67 μs |
| 30 kHz | 33.33 μs |
| 60 kHz | 16.67 μs |
| 120 kHz | 8.33 μs |

As illustrated in Table 1, as the SCS increases, the OFDM symbol length decreases. Because the AGC-RS length and the gap length are determined for each SCS, it is possible to configure a necessary length corresponding to the OFDM symbol length. Further, for example, the AGC-RS length and the gap length may be determined for each frequency range (FR) 1, each FR 2, or each frequency band, or the AGC-RS length and the gap length may be specified for each parameter of the FR 1, the FR 2, or the frequency band.

The AGC-RS length or the gap length may be determined by a constant multiple of the OFDM symbol length. The AGC-RS length or the gap length may be specified as a multiple of an OFDM symbol unit. Further, the AGC-RS length or the gap length may be specified in the technical specifications or may be indicated by a network or a transmission-side user device 20.

The AGC-RS length or the gap length may be defined to be less than one OFDM symbol. For example, as illustrated in FIG. 9, the AGC-RS length may be set to 0.5 symbols, and the gap length may be set to 0.5 symbols. Accordingly, it is possible to increase an overhead reduction effect of the AGC-RS length or the gap length especially in a non-slot design of NR. Further, as described above, in SL, unlike an ordinary TDD network, because the necessity of symbol synchronization is lowered, even if the AGC-RS length or the gap length is determined to be less than one OFDM symbol, influence of inter-link interference can be relatively reduced. For example, a sum of the AGC-RS length and the gap length may be one symbol. Further, for example, the sum of the AGC-RS length and the gap length may be a multiple of a symbol length.

Note that a PSCCH or a PSSCH may be multiplexed immediately after the AGC-RS. As illustrated in FIG. 9, 13 symbols of the PSCCH or the PSSCH may be multiplexed immediately after the AGC-RS with a 0.5-symbol length, and the gap may be multiplexed in a 0.5-symbol length. Further, the multiplexing position of the PSCCH or the PSSCH in the time domain may be defined relative to the position of the AGC-RS in the time domain.

Note that the PSCCH or the PSSCH may be multiplexed immediately after the gap period. Further, the multiplexing position of the PSCCH or PSSCH in the time domain may be defined relative to the position of the gap period in the time domain.

Further, the PSSCH length may be calculated based on at least one of the AGC-RS length and the gap length. For example, the PSSCH length may be calculated based on the PSCCH length. For example, the PSSCH length may be calculated by subtracting the sum of the AGC-RS length, the gap length, and the PSCCH from the slot length.

Note that the user device 20 may indicate, to the base station device 10 or another user device 20, the necessity of the AGC-RS or the gap, and the AGC-RS length or the gap length which is supported as capability signaling.

Further, for example, when links of a plurality of consecutive slots are the same, the AGC-RS need not be multiplexed in a slot at a subsequent stage. Accordingly, the presence or absence of AGC-RS multiplexing may be specified in accordance with links of consecutive slots. For example, when there is no change in transmission/reception links of consecutive slots, the AGC-RS need not be multiplexed in each link. The transmission/reception links may be specified as a pair of transmission/reception terminals.

Further, the presence or absence of AGC-RS multiplexing may be indicated. For example, the presence or absence of multiplexing of the AGC-RS in a subsequent slot may be indicated by the user device 20. Further, for example, the periodical or semi-persistent multiplexing of AGC-RS may be indicated by the user device 20 or the base station device 10. This indication is effective in a link in which communication is periodically performed. Further, for example, a period, a timing offset, or an activation/deactivation command with which the AGC-RS is multiplexed may be signaled.

Further, for example, when types of transmission/reception of a plurality of consecutive slots are the same, the gap is unnecessary. Further, if transmission/reception is not scheduled in a slot at a subsequent stage, the gap is unnecessary.

In this regard, when the types of transmission and reception of a plurality of consecutive slots are identical to each other, the gap period may not be set. The presence or absence of the gap period may be determined in accordance with the type of SL reception or DL reception. Further, the presence or absence of a gap period may be determined in accordance with the type of SL transmission or UL transmission. Further, the presence or absence of the gap period may be indicated. An indication of the presence or absence of a gap period may be provided to the user device 20 through, for example, the AGC-RS, the PSCCH, the PSSCH, or the like.

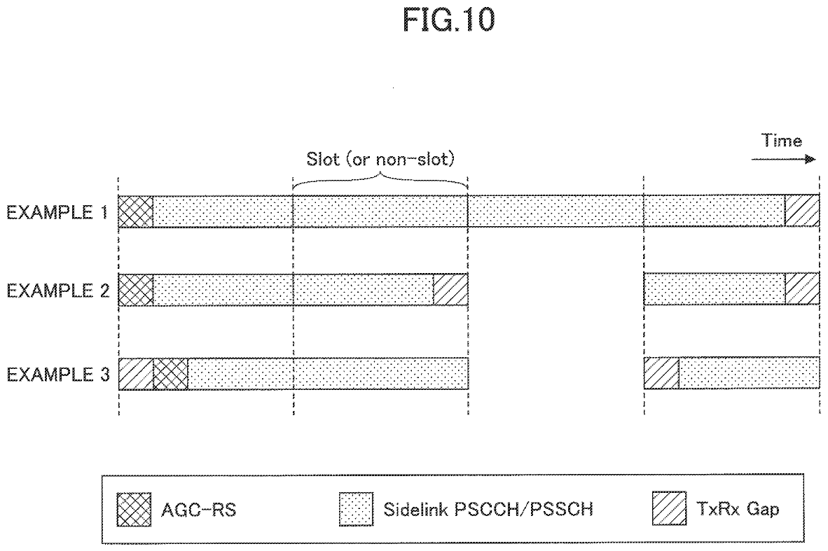

FIG. 10 is a diagram illustrating an example of scheduling of sidelink in an embodiment of the present invention. An example in which a plurality of slots are scheduled in SL will be described with reference to FIG. 10. As illustrated in FIG. 10, a slot may be a non-slot.

As in Example 1, a common AGC-RS may be applied in a plurality of scheduled slots. Further, as in Example 2, a common AGC-RS may be applied even when there are some unscheduled slots among a plurality of scheduled consecutive slots. Further, as in Example 3, when there are one or more unscheduled slots between one or more scheduled slots, no gap may be set at the end of a slot.

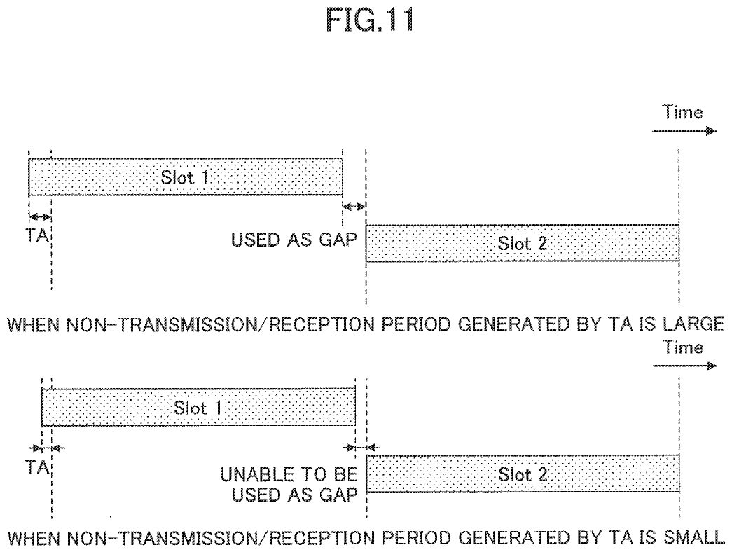

FIG. 11 is a diagram illustrating an example of a gap by timing advance (TA) of sidelink in an embodiment of the present invention. The presence or absence of the gap period or the gap length may be specified in accordance with a TA value. When a non-transmission/reception period generated by the TA is greater than a time necessary for the transmission/reception switching, the user device 20 may execute the transmission/reception switching using the period of the TA as a gap. On the other hand, when the non-transmission/reception period generated by the TA is less than the time necessary for the transmission/reception switching, the period of the TA is unable to be used as a gap, and thus the user device 20 needs a separate gap to execute the transmission/reception switching.

For example, when the TA value is equal to or greater than a certain value, the gap period may not be set, and when the TA value is equal to or less than, or less than, a certain value, the gap period may be set. The determination of the TA value may be based on the TA value of one user device 20 or may be based on a difference between the TA value of a user device 20 using a slot 1 and the TA value of a user device 20 using a slot 2.

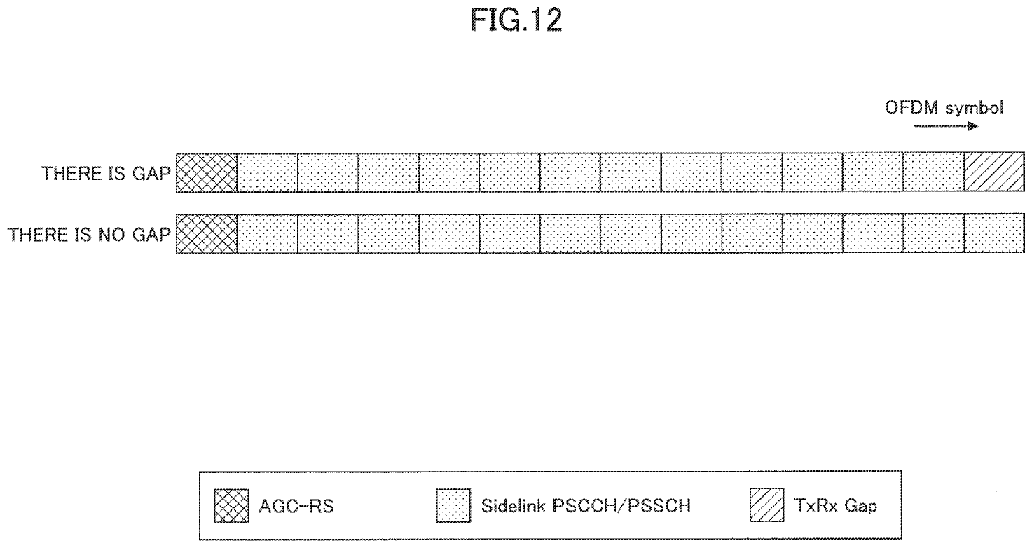

FIG. 12 is a diagram illustrating an example of a gap configuration of sidelink in an embodiment of the present invention. Table 2 shows conditions of two consecutive slots when a slot with a gap or a slot with no gap as illustrated in FIG. 12 is arranged as the slot 1. “Tx” in Table 2 indicates transmission, “Rx” indicates reception, and “No TRx” indicates no transmission/reception.

TABLE 2

| Slot 1 | Slot 2 | Gap |
|---|---|---|
| Tx | No TRx | Unnecessary |
| Tx | Tx | Unnecessary |
| Tx | Rx | Necessary |
| Rx | No TRx | Unnecessary |
| Rx | Tx | Necessary |
| Rx | Rx | Unnecessary |
| No TRx | Tx | Unnecessary |
| No TRx | Rx | Unnecessary |
| No TRx | No TRx | Unnecessary |

As shown in Table 2, when a slot 1 is Tx, and a slot 2 is No TRx, no gap is necessary in the slot 1. Further, when a slot 1 and a slot 2 are Tx, no gap is required for the slot 1. Further, when a slot 1 is Tx, and a slot 2 is Rx, a gap is required for the slot 1. Further, when a slot 1 is Rx, and a slot 2 is TRx, no gap is necessary for the slot 1. When a slot 1 is Rx, and a slot 2 is Tx, a gap is necessary in the slot 1. Further, when a slot 1 is Rx, and a slot 2 is Rx, no gap is necessary in the slot 1. Further, when a slot 1 is No TRx, and a slot 2 is Tx, no gap is necessary in the slot 1. Further, when a slot 1 is No TRx, and a slot 2 is Rx, no gap is necessary in the slot 1. Further, when a slot 1 is No TRx, and a slot 2 is No TRx, no gap is necessary in the slot 1.

A specific signal corresponding to the AGC-RS may be a primary synchronization signal (PSS) or a secondary synchronization signal (SSS). The synchronization accuracy in reception of a PSCCH or a PSSCH may be increased by setting the PSS or the SSS as an AGC-RS. Further, the synchronization accuracy of the AGC-RS may be increased by multiplexing a tracking CSI-RS at a first symbol. Alternatively, the specific signal may be another reference signal specified for SL.

In an embodiment of the present disclosure, the descriptions are mainly based on the assumption of NR channels and NR signaling schemes, but an embodiment of the present invention can be applied to channels and signaling having functions similar to those of NR. For example, an embodiment of the present invention can be applied to LTE or LTE-A.

Although various signaling examples have been described in the present disclosure, the signaling is not limited to explicit methods, and the signaling may be implicitly indicated or uniquely specified in the technical specifications.

Further, although various signaling examples have been described in the present disclosure, the signaling may be signaling of radio resource control (RRC), media access control control element (MACCE), downlink control information (DCI), or the like, or the signaling may be signaling of master information block (MIB), system information block (SIB), or the like. For example, RRC and DCI may be combined, RRC and MACCE may be combined, or other combinations of signaling may be used. The signaling may be performed by a gNB, a transmitter of SL may perform the signaling for a receiver, or the receiver of SL may perform reporting to a gNB or a transmitter.

In the present disclosure, the examples of the cases of the slot configuration (14-symbol packet) have been mainly described, but they can be applied to a non-slot configuration (packet of less than 14 symbols).

In the present disclosure, embodiments can be combined with each other, and the features described in these embodiments can be combined with each other in various combinations. The present invention is not limited to a specific combination disclosed in the present specification.

In the present disclosure, the descriptions are based on the slot configuration mainly using SL, but the technology in the present disclosure can be applied to environments in which DL, UL, and SL are used in a mixed manner.

According to the above-described embodiment, the user device 20 can transmit a signal with high resource usage efficiency by flexibly changing the arrangement of the AGC-RS or the gap. Further, it is possible to transmit a signal with high resource usage efficiency by preventing arrangement of an unnecessary AGC-RS or gap and arranging a control signal or a data signal.

In other words, in D2D direct communication, the user device can execute communication with high transmission efficiency using a signal format with less restrictions.

(Device Configuration)

Next, a functional configuration example of each of the base station device 10 and the user device 20 that execute the processes and the operation described so far will be described. Each of the base station device 10 and the user device 20 has functions of implementing the embodiments. Here, each of the base station device 10 and the user device 20 may have only some of the functions in the embodiments.

<Base Station Device 10>

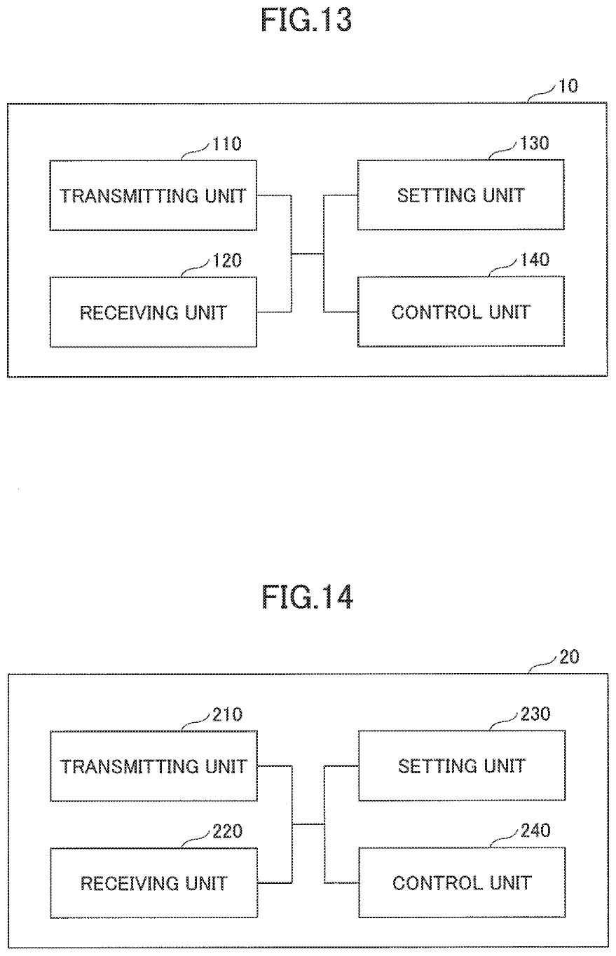

FIG. 13 is a diagram illustrating an example of a functional configuration of the base station device 10. As illustrated in FIG. 13, the base station device 10 has a transmitting unit 110, a receiving unit 120, a setting unit 130, and a control unit 140. The functional configuration illustrated in FIG. 13 is merely an example. As long as the operation according to an embodiment of the present invention can be executed, the function classification and the name of the function unit may be any classification and any name.

The transmitting unit 110 has a function of generating a signal to be transmitted to the user device 20 and transmitting the signal wirelessly. The receiving unit 120 has a function of receiving various types of signals transmitted from the user device 20 and acquiring, for example, information of a higher layer from the received signals. The transmitting unit 110 has a function of transmitting the NR-PSS, the NR-SSS, the NR-PBCH, the DL/UL control signal, the DL reference signal, or the like to the user device 20.

The setting unit 130 stores pre-configured configuration information and various types of configuration information to be transmitted to the user device 20 in the storage device and reads the configuration information from the storage device if necessary. For example, content of the configuration information is, for example, information related to a configuration of the D2D communication or the like.

As described in the embodiment, the control unit 140 performs a process related to the configuration used for the user device 20 to perform the D2D communication. Further, the control unit 140 performs a process related to the determination of the resource used for transmission of the synchronization signal and the broadcast information of the D2D communication. The control unit 140 transmits the scheduling of the D2D communication to the user device 20 via the transmitting unit 110. A functional unit related to signal transmission in the control unit 140 may be included in the transmitting unit 110, and a functional unit related to signal reception in the control unit 140 may be included in the receiving unit 120.

<User Device 20>

FIG. 14 is a diagram illustrating an example of a functional configuration of the user device 20. As illustrated in FIG. 14, the user device 20 has a transmitting unit 210, a receiving unit 220, a setting unit 230, and a control unit 240. The functional configuration illustrated in FIG. 14 is merely an example. As long as the operation according to an embodiment of the present invention can be executed, the function classification and the name of the function unit are not consequential.

The transmitting unit 210 generates a transmission signal from transmission data and transmits the transmission signal wirelessly. The receiving unit 220 wirelessly receives various types of signals, and acquires a signal of a higher layer from a received signal of a physical layer. The receiving unit 220 also has a function of receiving the NR-PSS, the NR-SSS, the NR-PBCH, the DL/UL/SL control signal, the reference signal, or the like transmitted from the base station device 10. Further, for example, the transmitting unit 210 may transmit a physical sidelink control channel (PSCCH), a physical sidelink shared channel (PSSCH), a physical sidelink discovery channel (PSDCH), a physical sidelink broadcast channel (PSBCH), and the like to other user devices 20 as the D2D communication, and the receiving unit 220 receives the PSCCH, the PSSCH, the PSDCH, the PSBCH, and the like from other user devices 20.

The setting unit 230 stores various types of configuration information received from the base station device 10 or the user device 20 through the receiving unit 220 in the storage device and reads the configuration information from the storage device if necessary. The setting unit 230 also stores pre-configured configuration information. For example, content of the configuration information is, for example, information related to the configuration of the D2D communication or the like.

The control unit 240 controls the D2D communication with other user devices 20 as described in the embodiment. Further, the control unit 240 performs a process related to the AGC control on the basis of the synchronization signal or the reference signal of the D2D communication. Further, the control unit 240 may execute the scheduling of the D2D communication. A functional unit related to signal transmission in the control unit 240 may be included in the transmitting unit 210, and a functional unit related to signal reception in the control unit 240 may be included in the receiving unit 220.

(Hardware Configuration)

In the block diagrams (FIGS. 13 and 14) used for the description of the above embodiment, the blocks of the functional units are illustrated. The functional blocks (configuring units) are implemented by at least an arbitrary combination of hardware and/or software. A method of implementing each functional block is not particularly limited. In other words, each functional block may be implemented by one device in which a plurality of elements are physically and/or logically combined or may be implemented by a plurality of devices, that is, two or more devices which are physically and/or logically separated and are directly and/or indirectly connected (for example, in a wired and/or wireless manner or the like). The function block may be realized by combining software with one device or a plurality of devices.

The functions include determining, deciding, judging, computing, calculating, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like but are not limited thereto. For example, a functional block (configuring unit) that causes transmission to function is referred to as a transmitting unit or a transmitter. In any case, as described above, an implementation method is not particularly limited.

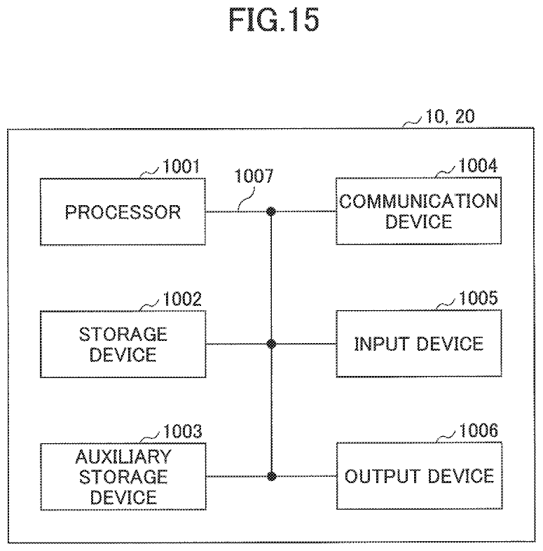

For example, the base station device 10, the user device 20, or the like in one embodiment of the present disclosure may function as a computer for processing the present disclosure's wireless communication method. FIG. 15 is a diagram illustrating an example of a hardware configuration of the base station device 10 and the user device 20 according to an embodiment of the present disclosure. Each of the base station device 10 and the user device 20 may be physically configured as a computer device including a processor 1001, a storage device 1002, an auxiliary storage device 1003, a communication device 1004, an input device 1005, an output device 1006, a bus 1007, and the like.

In the following description, the term “device” can be read as a circuit, device, unit, or the like. The hardware configuration of each of the base station device 10 and the user device 20 may be configured to include one or more devices illustrated in the drawing or may be configured without including some devices.

Each function in each of the base station device 10 and the user device 20 is implemented such that predetermined software (program) is read on hardware such as the processor 1001 and the storage device 1002, and the processor 1001 performs an operation and controls communication by the communication device 1004 and reading and/or writing of data in the storage device 1002 and the auxiliary storage device 1003.

For example, the processor 1001 operates an operating system and controls the entire computer. The processor 1001 may be configured with a central processing unit (CPU) including an interface with a peripheral device, a control device, an operation device, a register, and the like. For example, the control unit 140, the control unit 240, and the like described above may be implemented by the processor 1001.

Further, the processor 1001 reads a program (program code), a software module, or data from at least one of the auxiliary storage device 1003 and/or the communication device 1004 out to the storage device 1002, and executes various types of processes according to them. A program causing a computer to execute at least some of the operations described in the above embodiment is used as the program. For example, the control unit 140 of the base station device 10 illustrated in FIG. 13 may be implemented by a control program which is stored in the storage device 1002 and operates on the processor 1001. Further, for example, the control unit 240 of the user device 20 illustrated in FIG. 14 may be implemented by a control program which is stored in the storage device 1002 and operates on the processor 1001. Various types of processes have been described as being performed by one processor 1001 but may be performed simultaneously or sequentially by two or more processors 1001. The processor 1001 may be implemented by one or more chips. The program may be transmitted from a network via an electric communication line.

The storage device 1002 is a computer readable recording medium and configured with at least one of a read only memory (ROM), an erasable programmable ROM (EPROM), an electrically erasable programmable ROM (EEPROM), a random access memory (RAM), and the like. The storage device 1002 is also referred to as a “register,” a “cache,” a “main memory,” or the like. The storage device 1002 can store programs (program codes), software modules, or the like which are executable for carrying out the communication method according to an embodiment of the present disclosure.

The auxiliary storage device 1003 is a computer-readable recording medium and may be configured with, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The auxiliary storage device 1003 is also referred to as an “auxiliary storage device.” The storage medium may be, for example, a database, a server, or any other appropriate medium including at least one of the storage device 1002 and the auxiliary storage device 1003.

The communication device 1004 is hardware (a transceiving device) for performing communication between computers via at least one of a wired network and a wireless network and is also referred to as a “network device,” a “network controller,” a “network card,” a “communication module,” or the like. The communication device 1004 may include a high-frequency switch, a duplexer, a filter, a frequency synthesizer, or the like in order to implement at least one of frequency division duplex (FDD) and time division duplex (TDD). For example, a transceiving antenna, an amplifying unit, a transmitting/receiving unit, a transmission line interface, or the like may be implemented by the communication device 1004. The transmitting/receiving unit may be implemented by to be physically or logically separated by a transmitting unit and a receiving unit.

The input device 1005 is an input device that receives an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integratedly configured (for example, a touch panel).

The respective devices such as the processor 1001 and the storage device 1002 are connected via the bus 1007 to communicate information with each other. The bus 1007 may be configured with a single bus or may be configured with different buses between the devices.

Further, each of the base station device 10 and the user device 20 may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented using at least one of these pieces of hardware.

### Conclusion of Embodiment

As described above, according to an embodiment of the present invention, provided is a user device including a control unit that arranges a reference signal or a gap in a signal of D2D direct communication and a transmitting unit that transmits the signal of the D2D direct communication and information related to the reference signal or the gap to another user device.

With the above configuration, the user device 20 can transmit a signal with high resource usage efficiency by flexibly changing the arrangement of the AGC-RS or the gap. In other words, in D2D direct communication, the user device can execute communication with high transmission efficiency using a signal format with less restrictions.

In the signal of the D2D direct communication, the gap may be arranged at a beginning of a slot. With this configuration, the user device 20 can flexibly change the arrangement of the gap.

The user device according to claim 1, in which, in the signal of the D2D direct communication, a transient period at a beginning of a slot is used as a gap, and an explicit gap is not arranged. With this configuration, the user device 20 can transmit a signal with high resource usage efficiency by preventing arrangement of an unnecessary gap and arranging a control signal or a data signal.

In the signal of the D2D direct communication, a length of a reference signal and a length of a gap are variable, and the length of the reference signal and the length of the gap are configured or specified for each sub carrier space. The user device 20 can transmit a signal with high resource usage efficiency by arranging an AGC-RS and a gap by changing the AGC-RS length or the gap length.

In the signal of the D2D direct communication, when there are one or more unused slots among a plurality of consecutive slots, a common reference signal may be applied in slots to be used among the plurality of slots. With this configuration, the user device 20 can transmit a signal with high resource usage efficiency by preventing arrangement of an unnecessary AGC-RS and arranging a control signal or a data signal.

In the signal of the D2D direct communication, when a timing advance value is equal to or greater than a predetermined value, the gap may not be configured, and when the timing advance value is less than the predetermined value, the gap may be configured. With this configuration, the user device 20 can transmit a signal with high resource usage efficiency by preventing arrangement of an unnecessary gap and arranging a control signal or a data signal.

### Supplement of Embodiment

The exemplary embodiment of the present invention has been described above, but the disclosed invention is not limited to the above embodiments, and those skilled in the art would understand various modified examples, revised examples, alternative examples, substitution examples, and the like. In order to facilitate understanding of the invention, specific numerical value examples have been used for description, but the numerical values are merely examples, and certain suitable values may be used unless otherwise stated. The classification of items in the above description is not essential to the present invention. Matters described in two or more items may be combined and used if necessary, and a matter described in one item may be applied to a matter described in another item (unless inconsistent). The boundary between functional units or processing units in a functional block diagram does not necessarily correspond to the boundary between physical parts. Operations of a plurality of functional units may be performed physically by one component, or an operation of one functional unit may be physically performed by a plurality of parts. In the processing procedure described in the embodiments, the order of the processes may be changed as long as there is no inconsistency. For the sake of convenience of processing description, the base station device 10 and the user device 20 have been described using the functional block diagrams, but such devices may be implemented by hardware, software, or a combination thereof. Software executed by the processor included in the base station device 10 according to the embodiment of the present invention and software executed by the processor included in the user device 20 according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

Further, a notification of information is not limited to the aspect or embodiment described in the present disclosure and may be given by any other method. For example, the notification of information may be given by physical layer signaling (for example, downlink control information (DCI) or uplink control information (UCI)), upper layer signaling (for example, radio resource control (RRC) signaling, medium access control (MAC) signaling, broadcast information (master information block (MIB), system information block (SIB)), other signals, or a combination thereof. Further, the RRC signaling may be referred to as an RRC message and may be, for example, an RRC connection setup message, an RRC connection reconfiguration message, or the like.

Each aspect and embodiment of the present invention may be applied to at least one of Long Term Evolution (LTE), LTE-advanced (LTE-A), SUPER 3G, IMT-advanced, 4th generation mobile communication system (4G), 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), a system using any other appropriate system, and next generation systems extended on the basis of these standards. Further, a plurality of systems may be combined and applied (for example, a combination of at least one of LTE and LTE-A and 5G or the like).

The processing procedures, the sequences, the flowcharts, and the like of the respective aspects/embodiments described in this specification may be reversed in order unless there is a contradiction. For example, the method described in the present disclosure presents elements of various steps using an exemplary order and is not limited to a presented specific order.

In this specification, a specific action that is supposed to be performed by the base station device 10 may be performed by an upper node in some cases. In the network including one or more network nodes including the base station device 10, various operations performed for communication with the user device 20 can be obviously performed by at least one of the base station and any network node (for example, an MME, an S-GW, or the like is considered, but it is not limited thereto) other than the base station device 10 and/or the base station device 10. The example in which the number of network nodes excluding the base station device 10 is one has been described above, but other network nodes in which a plurality of other network nodes (for example, an MME and an S-GW) are combined may be provided.

Information, a signal, or the like described in the present disclosure may be output from an upper layer (or a lower layer) to a lower layer (or an upper layer). Information, a signal, or the like described in the present disclosure may be input and output via a plurality of network nodes.

Input and output information and the like may be stored in a specific place (for example, a memory) or may be managed through a management table. Input and output information and the like may be overwritten, updated, or additionally written. Output information and the like may be deleted. Input information and the like may be transmitted to another device.

The determination the present disclosure may be performed in accordance with a value (0 or 1) indicated by one bit, may be performed in accordance with a Boolean value (true or false), or may be performed by a comparison of numerical values (for example, a comparison with a predetermined value).

Software can be interpreted widely to mean a command, a command set, a code, a code segment, a program code, a program, a subprogram, a software module, an application, a software application, a software package, a routine, a subroutine, an object, an executable file, an execution thread, a procedure, a function, and the like regardless of whether software is called software, firmware, middleware, a microcode, a hardware description language, or any other name.

Further, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL)) and a radio technology (such as infrared rays or a microwave), at least one of the wired technology and the radio technology are included in a definition of a transmission medium.

Information, signals, and the like described in this specification may be indicated using any one of a variety of different techniques. For example, data, instructions, commands, information, signals, bits, symbols, chips, and the like which are mentioned throughout the above description may be indicated by voltages, currents, electromagnetic waves, magnetic particles, optical fields or photons, or an arbitrary combination thereof.

The terms described in the present disclosure and terms necessary for understanding the present disclosure may be replaced with terms having the same or similar meanings. For example, at least one of a channel and a symbol may be a signal. Further, a signal may be a message. Further, a component carrier (CC) may be referred to as a “carrier frequency,” a “cell,” or the like.

The terms “system” and “network” used in the present disclosure are used interchangeably.

Further, information, parameters, and the like described in the present disclosure may be indicated by absolute values, may be indicated by relative values from predetermined values, or may be indicated by corresponding other information. For example, radio resources may be those indicated by an index.

The names used for the above-described parameters are not limited in any respect. Further, mathematical formulas or the like using the parameters may be different from those explicitly disclosed in the present disclosure. Since various channels (for example, a PUCCH, a PDCCH, and the like) and information elements can be identified by suitable names, various names allocated to the various channels and the information elements are not limited in any respect.

In the present disclosure, the terms “base station (BS),” “radio base station,” “base station device,” “fixed station,” “Node B,” “eNode B (eNB),” “gNodeB (gNB),” “access point,” “transmission point,” “reception point,” “transmission/reception point,” “cell,” “sector,” “cell group,” “carrier,” “component carrier,” and the like can be used interchangeably. The base stations may also be indicated by terms such as a macrocell, a small cell, a femtocell, and a picocell.

The base station eNB can accommodate one or more (for example, three) cells. In a case in which the base station accommodates a plurality of cells, the entire coverage area of the base station can be partitioned into a plurality of small areas, and each small area can provide a communication service through a base station subsystem (for example, a small indoor base station (a remote radio head (RRH)). The term “cell” or “sector” refers to the whole or a part of the coverage area of at least one of the base station and the base station subsystem that performs a communication service in the coverage.

In the present disclosure, the terms “mobile station (MS),” “user terminal,” “user device (UE),” “terminal,” and the like can be used interchangeably.

The mobile station may be a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, It may also be referred to as a remote terminal, handset, user agent, mobile client, client, or some other suitable term.

At least one of the base station and the mobile station may be also referred to as a transmitting device, a receiving device, a communication device, or the like. At least one of the base station and the mobile station may be a device installed in a mobile body, a mobile body itself, or the like. The moving body may be a vehicle (for example, a car, an airplane, or the like), a moving body that moves unmanned (for example, a drone, an autonomous car or the like), or a robot (manned type or unmanned type). At least one of the base station and the mobile station includes a device which need not necessarily move during a communication operation. For example, at least one of the base station and the mobile station may be an Internet of things (IoT) device such as a sensor.

Further, the base station in the present disclosure may be replaced with a user terminal. For example, each aspect/embodiment of the present disclosure may be applied to a configuration in which communication between the base station and the user terminal is replaced with communication between a plurality of user devices 20 (for example, which may be referred to as device-to-device (D2D) or vehicle-to-everything (V2X)). In this case, the user device 20 may have the functions of the base station described above. Further, the terms “uplink” and “downlink” may be replaced with terms (for example, “side”) corresponding to inter-terminal communication. For example, an uplink channel, a downlink channel, or the like may be read with side channels.

Similarly, the user terminal in the present disclosure may be replaced with the base station. In this case, the base station may have the functions of the above-mentioned user terminal.

The term “determining” used in this specification may include a wide variety of actions. For example, “determining” may include, for example, events in which events such as judging, calculating, computing, processing, deriving, investigating, looking up, search, and inquiry (for example, looking up in a table, a database, or another data structure), or ascertaining are regarded as “determining.” Further, “determining” may include, for example, events in which events such as receiving (for example, receiving information), transmitting (for example, transmitting information), input, output, or accessing (for example, accessing data in a memory) are regarded as “determining.” Further, “determining” may include, for example, events in which events such as resolving, selecting, choosing, establishing, or comparing are regarded as “determining.” In other words, “determining” may include events in which a certain operation is regarded as “determining.” Further, “determining” may be replaced with “assuming,” “expecting,” “considering,” or the like.

Terms “connected,” “coupled,” or variations thereof means any direct or indirect connection or coupling between two or more elements and may include the presence of one or more intermediate elements between two elements which are “connected” or “coupled.” The coupling or the connection between the elements may be physical, logical, or a combination thereof. For example, “connection” may be replaced with “access.” In a case in which used in the present disclosure, two elements may be considered to be “connected” or “coupled” with each other using at least one of one or more electric wires, cables and/or a printed electrical connection or using electromagnetic energy having a wavelength in a radio frequency domain, a microwave region, or a light (both visible and invisible) region as non-limiting and non-exhaustive examples.

A reference signal may be abbreviated as RS and may be referred to as a pilot, depending on a standard to be applied.

A phrase “on the basis of” used in the present disclosure is not limited to “on the basis of only” unless otherwise stated. In other words, a phrase “on the basis of” means both “on the basis of only” and “on the basis of at least.”

Any reference to an element using a designation such as “first,” “second,” or the like used in the present disclosure does not generally restrict quantities or an order of those elements. Such designations can be used in the present disclosure as a convenient method of distinguishing two or more elements. Thus, reference to the first and second elements does not mean that only two elements can be adopted there, or the first element must precede the second element in a certain form.

Further, “means” in the configuration of each of the above devices may be replaced with “unit,” “circuit,” “device,” or the like.

In a case in which “include,” “including,” and variations thereof are used in the present disclosure, these terms are intended to be comprehensive, similarly to a term “equipped with (comprising).” Further, the term “or” used in the present disclosure is intended not to be an exclusive disjunction.

A radio frame may include one or more frames in the time domain. In the time domain, each of one or more frames may be referred to as a sub frame. The sub frame may further include one or more slots in the time domain. The sub frame may have a fixed time length (for example, 1 ms) not depending on numerology.

The numerology may be a communication parameter applied to at least one of transmission and reception of a certain signal or channel. For example, the numerology may indicate at least one of a sub carrier spacing (SCS), a bandwidth, a symbol length, a cyclic prefix length, a transmission time interval (TTI), a number of symbols per TTI, a radio frame configuration, a specific filtering process performed in the frequency domain by a transceiver, a specific windowing process performed in the time domain by a transceiver, and the like.

The slot may include one or more symbols (orthogonal frequency division multiplexing (OFDM) symbols, single carrier frequency division multiple access (SC-FDMA) symbols, or the like) in the time domain. The slot may be a time unit based on the numerology.

The slot may include a plurality of mini slots. Each mini slot may include one or more symbols in the time domain. Further, the mini slot may be referred to as a sub-slot. The mini slot may include fewer symbols than a slot. A PDSCH (or PUSCH) transmitted in units of times greater than the mini slot may be referred to as a PDSCH (or PUSCH) mapping type A. A PDSCH (or PUSCH) transmitted using a mini slot may be referred to as a PDSCH (or PUSCH) mapping type B.

All of a radio frame, a sub frame, a slot, a mini slot, and a symbol indicates a time unit for transmitting a signal. As a radio frame, a sub frame, a slot, a mini slot, and a symbol, different designations respectively corresponding to them may be used.

For example, one sub frame may be referred to as a transmission time interval (TTI: Transmission Time Interval), or a plurality of consecutive sub frames may be referred to as TTIs, or one slot or one mini slot may be referred to as a TTI. In other words, at least one of the sub frame and the TTI may be a sub frame (1 ms) in the existing LTE, may be a period shorter than 1 ms (for example, 1 to 13 symbols), or may be referred to as a period longer than 1 ms. A unit representing the TTI may be referred to as slot, a mini slot, or the like instead of the sub frame.

Here, for example, the TTI refers to a minimum time unit of scheduling in wireless communication. For example, in the LTE system, the base station performs scheduling of allocating a radio resource (a frequency bandwidth, a transmission power, or the like which can be used in each user device 20) to each user device 20 in units of TTIs. The definition of the TTI is not limited thereto.

The TTI may be a transmission time unit such as a channel coded data packet (transport block), a code block, or a code word, or may be a processing unit such as scheduling or link adaptation. Further, when a TTI is given, a time interval (for example, the number of symbols) in which a transport block, a code block, a code word, or the like is actually mapped may be shorter than the TTI.

Further, when one slot or one mini slot is referred to as a TTI, one or more TTIs (that is, one or more slots or one or more mini slots) may be a minimum time unit of scheduling. Further, the number of slots (the number of mini slots) constituting the minimum time unit of scheduling may be controlled.

A TTI having a time length of 1 ms may be referred to as a common TTI (TTI in LTE Rel. 8 to 12), a normal TTI, a long TTI, a common sub frame, a normal sub frame, a long sub frame, a slot, or the like. A TTI shorter than the common TTI may be referred to as a reduced TTI, a short TTI, a partial TTI (a partial or fractional TTI), a reduced sub frame, a short sub frame, a mini slot, a sub slot, a slot, or the like.

Further, a long TTI (for example, a common TTI, a sub frame, or the like) may be replaced with a TTI having a time length exceeding 1 ms, and a short TTI (for example, a reduced TTI or the like) may be replaced with a TTI having a TTI length which is less than a TTI length of a long TTI and equal to or more than 1 ms.

The resource block (RB) is a resource allocation unit in the time domain and the frequency domain and may include one or more consecutive sub carriers in the frequency domain. The number of sub carriers included in an RB may be the same irrespective of a numerology and may be, for example, 12. The number of sub carriers included in an RB may be determined on the basis of a numerology.

Further, a time domain of an RB may include one or more symbols and may be a length of one slot, one mini slot, one sub frame, or one TTI. Each of one TTI, one sub frame, or the like may be constituted by one or more resource blocks.

Further, one or more RBs may be referred to as a physical resource block (PRB), a sub carrier group (SCG), a resource element group (REG), a PRB pair, a RB pair, or the like.

Further, the resource block may be constituted by one or more resource elements (RE). For example, one RE may be a radio resource region of one sub carrier and one symbol.

A bandwidth part (BWP) (which may be referred to as a partial bandwidth) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include a BWP for UL (UL BWP) and a BWP for DL (DL BWP). In a UE, one or more BWPs may be configured within one carrier.

At least one of configured BWPs may be active, and it may not be assumed that the UE transmits and receives a predetermined signal/channel outside an active BWP. Further, a “cell,” a “carrier,” or the like in the present disclosure may be replaced with a “BWP.”

Structures of the radio frame, the sub frame, slot, the mini slot, and the symbol are merely examples. For example, configurations such as the number of sub frames included in a radio frame, the number of slots per sub frame or radio frame, the number of mini slots included in a slot, the number of symbols and RBs included in a slot or a mini slot, the number of sub carriers included in an RB, the number of symbols in a TTI, a symbol length, a cyclic prefix (CP) length, and the like can be variously changed.

In the entire present disclosure, for example, when an article such as “a,” “an,” or “the” in English is added by a translation, the present disclosure may include a case in which a noun following the article is the plural.

In the present disclosure, a term “A and B are different” may mean “A and B are different from each other.” Further, the term may mean “each of A and B is different from C.” Terms such as “separated,” “coupled,” or the like may also be interpreted in similarly to “different.”

Each aspect/embodiment described in this specification may be used alone, in combination, or may be switched in accordance with the execution. Further, notification of predetermined information (for example, notification of “being X”) is not limited to being performed explicitly, but is performed by implicit (for example, not notifying the predetermined information) It is also good.

In the present disclosure, the AGC-RS is an example of a reference signal.

Although the present disclosure has been described above in detail, it is obvious to those skilled in the art that the present disclosure is not limited to the embodiments described in the present disclosure. The present disclosure may be implemented as revised and modified forms without departing from the gist and scope of the present disclosure as configured forth in claims. Therefore, the description of the present disclosure is for the purpose of illustration and does not have any restrictive meaning to the present disclosure.

### EXPLANATIONS OF LETTERS OR NUMERALS

10 BASE STATION DEVICE
110 TRANSMITTING UNIT
120 RECEIVING UNIT
130 SETTING UNIT
140 CONTROL UNIT
20 USER DEVICE
210 TRANSMITTING UNIT
220 RECEIVING UNIT
230 SETTING UNIT
240 CONTROL UNIT
1001 PROCESSOR
1002 STORAGE DEVICE
1003 AUXILIARY STORAGE DEVICE
1004 COMMUNICATION DEVICE
1005 INPUT DEVICE
1006 OUTPUT DEVICE

1. A user device, comprising:
a control unit that arranges a reference signal or a gap in a signal of D2D direct communication; and
a transmitting unit that transmits the signal of the D2D direct communication and information related to the reference signal or the gap to another user device.

2. The user device according to claim 1, wherein, in the signal of the D2D direct communication, the gap is arranged at a beginning of a slot.

3. The user device according to claim 1, wherein, in the signal of the D2D direct communication, a transient period at a beginning of a slot is used as the gap, and an explicit gap is not arranged.

4. The user device according to claim 1, wherein, in the signal of the D2D direct communication, a length of the reference signal and a length of the gap are variable, and the length of the reference signal and the length of the gap are configured or specified for each sub carrier space.

5. The user device according to claim 1, wherein, in the signal of the D2D direct communication, when there are one or more unused slots among a plurality of consecutive slots, a common reference signal is applied in slots to be used among the plurality of slots.

6. The user device according to claim 1, wherein, in the signal of the D2D direct communication, when a timing advance value is equal to or greater than a predetermined value, the gap is not configured, and when the timing advance value is less than the predetermined value, the gap is configured.
